(19) United States
(12) Patent Application Publication
(10) Pub. No.: US 2026/0161615 A1
(43) Pub. Date: Jun. 11, 2026

(54) DATABASE-AGNOSTIC ASYNCHRONOUS PRODUCT REPLICATION WITH ATOMIC ENTITIES

(71) Applicant: OKTA, INC., SAN FRANCISCO, CA (US)

(72) Inventors: Daniel Justin Mican, Sykesville, MD (US); Francisco Javier Sigler Gómez, Malaga (ES); Andrew Ryan Hawker, Portland, OR (US); Michael John O’Keefe, Grand Rapids, MI (US)

(21) Appl. No.: 18/977,737

(22) Filed: Dec. 11, 2024

(51) Int. Cl. G06F 16/21; G06F 21/31

(52) U.S. Cl. CPC G06F 16/214; G06F 21/31

(57) ABSTRACT

Methods, devices, and non-transitory computer-readable media are described. A migration controller device may receive a request to migrate data corresponding to a product from a source environment to a target environment. One or more source databases, in the source environment, that include product entities associated with the product may be identified. The migration controller device may cause one or more source agents associated with the one or more source databases to export, into a payload-agnostic data structure, product entity source data associated with the one or more product entities. The migration controller device may cause one or more target agents associated with one or more target databases in the target environment to import, from the payload-agnostic data structure and into the one or more target databases, the product entity source data, where the product entity source data may be imported in accordance with one or more migration rules.

### FIELD OF TECHNOLOGY

The present disclosure relates generally to identity management, and more specifically to database-agnostic asynchronous product replication with atomic entities.

### BACKGROUND

An identity management system may be employed to manage and store various forms of user data, including usernames, passwords, email addresses, permissions, roles, group memberships, etc. The identity management system may provide authentication services for applications, devices, users, and the like. The identity management system may enable organizations to manage and control access to resources, for example, by serving as a central repository that integrates with various identity sources. The identity management system may provide an interface that enables users to access a multitude of applications with a single set of credentials. Some identity management systems may need to replicate or migrate their customers' data from one environment to another, such as to provide the customer with different or additional system resources. In some cases, the identity management system may maintain such data in a distributed database environment, in which a given customer's data may be spread across multiple databases.

Because some replication technologies may operate at the database level, with each database operating with its own native database replication technology, the process of migrating data in distributed database environments may require a database-by-database approach, which may be time-consuming and inefficient. Furthermore, such a piecemeal approach to the migration process may present challenges in ensuring the integrity of dependencies associated with the data, particularly when such migrations must occur in real time, which in turn may prevent the seamless migration of data from one environment to another.

### SUMMARY

The described techniques relate to improved methods, systems, devices, and computer-readable media that support database-agnostic asynchronous product replication with atomic entities. For example, the described techniques provide a framework for replicating and migrating data in a database agnostic manner while preserving the integrity of data dependencies associated with the data.

A method by a migration controller device associated with a migration platform is described. The method may include receiving a request to migrate, from a source environment to a target environment, data corresponding to a product associated with a customer, identifying, in the source environment, one or more source databases that include one or more product entities associated with the product, migrating the data corresponding to the product, where migrating the data includes, causing each of one or more source agents associated with the one or more source databases to export, into a payload-agnostic data structure, product entity source data associated with the one or more product entities, where the one or more source databases are associated with one or more different database technologies, and causing one or more target agents associated with one or more target databases in the target environment to import, from the payload-agnostic data structure and into the one or more target databases, the product entity source data, where the product entity source data is imported in accordance with one or more migration rules.

A migration controller device associated with a migration platform is described. The migration controller device associated with a migration platform may include one or more memories storing processor executable code, and one or more processors coupled with the one or more memories. The one or more processors may individually or collectively be operable to execute the code to cause the migration controller device associated with a migration platform to receive a request to migrate, from a source environment to a target environment, data corresponding to a product associated with a customer, identify, in the source environment, one or more source databases that include one or more product entities associated with the product, migrate the data corresponding to the product, where migrating the data includes, cause each of one or more source agents associated with the one or more source databases to export, into a payload-agnostic data structure, product entity source data associated with the one or more product entities, where the one or more source databases are associated with one or more different database technologies, and cause one or more target agents associated with one or more target databases in the target environment to import, from the payload-agnostic data structure and into the one or more target databases, the product entity source data, where the product entity source data is imported in accordance with one or more migration rules.

Another migration controller device associated with a migration platform is described. The migration controller device associated with a migration platform may include means for receiving a request to migrate, from a source environment to a target environment, data corresponding to a product associated with a customer, means for identifying, in the source environment, one or more source databases that include one or more product entities associated with the product, means for migrating the data corresponding to the product, where migrating the data includes, means for causing each of one or more source agents associated with the one or more source databases to export, into a payload-agnostic data structure, product entity source data associated with the one or more product entities, where the one or more source databases are associated with one or more different database technologies, and means for causing one or more target agents associated with one or more target databases in the target environment to import, from the payload-agnostic data structure and into the one or more target databases, the product entity source data, where the product entity source data is imported in accordance with one or more migration rules.

A non-transitory computer-readable medium storing code is described. The code may include instructions executable by one or more processors to receive a request to migrate, from a source environment to a target environment, data corresponding to a product associated with a customer, identify, in the source environment, one or more source databases that include one or more product entities associated with the product, migrate the data corresponding to the product, where migrating the data includes, cause each of one or more source agents associated with the one or more source databases to export, into a payload-agnostic data structure, product entity source data associated with the one or more product entities, where the one or more source databases are associated with one or more different database technologies, and cause one or more target agents associated with one or more target databases in the target environment to import, from the payload-agnostic data structure and into the one or more target databases, the product entity source data, where the product entity source data is imported in accordance with one or more migration rules.

Some examples of the method, migration controller device associated with a migration platforms, and non-transitory computer-readable medium described herein may further include operations, features, means, or instructions for streaming one or more data streams from the one or more source databases into buffer storage, causing the one or more source agents to listen for database events at the one or more data streams, receiving, from a first source agent of the one or more source agents, an indication that a database event associated with a first entity may be detected at first data stream corresponding to a first source database of the one or more source databases, causing, based on detecting the database event, the first source agent to collect, from one or more other source databases, data associated with one or more additional entities that may be associated with the first entity, causing the first source agent to store the collected data in the buffer storage, and causing, after completion of the migration, the one or more target agents to apply data from the buffer storage to the one or more target databases in accordance with the one or more migration rules.

In some examples of the method, migration controller device associated with a migration platform, and non-transitory computer-readable medium described herein, each source agent of the one or more source agents may be configured to communicate with a corresponding source database of the one or more source databases.

In some examples of the method, migration controller device associated with a migration platform, and non-transitory computer-readable medium described herein, the one or more migration rules include one or more rules for determining, based on a dependency graph, an order for importing the product entity source data.

In some examples of the method, migration controller device associated with a migration platform, and non-transitory computer-readable medium described herein, the one or more product entities include a tenant, a user, a permission, an organization, a token, or a user search.

In some examples of the method, migration controller device associated with a migration platform, and non-transitory computer-readable medium described herein, the request to migrate data may be received based on a subscription ratio associated with the source environment satisfying a threshold ratio.

In some examples of the method, migration controller device associated with a migration platform, and non-transitory computer-readable medium described herein, the request to migrate data may be received based on an availability of multi-subscriber resources in the source environment satisfying a threshold.

Some examples of the method, migration controller device associated with a migration platform, and non-transitory computer-readable medium described herein may further include operations, features, means, or instructions for monitoring one or more quality of service (QoS) metrics associated with the one or more source databases and the one or more target databases, where the one or more QoS metrics include a quantity of records migrated to the one or more target databases, a quantity of records remaining in the one or more source databases, a percentage of the records from the one or more source databases that may have been successfully migrated to the one or more target databases, a time lag associated with the migration, or a data freshness.

Some examples of the method, migration controller device associated with a migration platform, and non-transitory computer-readable medium described herein may further include operations, features, means, or instructions for sending, to an operator, a notification of the at least one QoS metric and initiating a second request to migrate data corresponding to the product. In some examples of the method, migration controller device associated with a migration platform, and non-transitory computer-readable medium described herein, identifying, based on the one or source databases, the one or more target databases into which to import the product entity source data.

### BRIEF DESCRIPTION OF THE DRAWINGS

FIG. 1 illustrates an example of a computing system that supports database-agnostic asynchronous product replication with atomic entities in accordance with aspects of the present disclosure.

FIG. 2 shows an example of a system architecture that supports database-agnostic asynchronous product replication with atomic entities in accordance with aspects of the present disclosure.

FIG. 3 shows an example of a dependency graph that supports database-agnostic asynchronous product replication with atomic entities in accordance with aspects of the present disclosure.

FIG. 4 shows a block diagram of an apparatus that supports database-agnostic asynchronous product replication with atomic entities in accordance with aspects of the present disclosure.

FIG. 5 shows a block diagram of a controller that supports database-agnostic asynchronous product replication with atomic entities in accordance with aspects of the present disclosure.

FIG. 6 shows a diagram of a system including a device that supports database-agnostic asynchronous product replication with atomic entities in accordance with aspects of the present disclosure.

FIG. 7 shows a flowchart illustrating methods that support database-agnostic asynchronous product replication with atomic entities in accordance with aspects of the present disclosure.

### DETAILED DESCRIPTION

Cloud computing provides for the delivery of computing services or resources over the Internet. Such services and resources may include software applications, data storage, databases, servers, virtual machines, operating systems, analytics, computing environments or platforms, authentication services, etc. Some organizations may use cloud computing to increase performance, manage computing and operating costs, provide for on-demand scalability of computing resources, improve reliability, and many other reasons. However, the use of cloud computing may present certain security vulnerabilities. As such, in order to ensure the security of an organization's cloud resources and, in some cases, the organization's on-premises resources as well, the organization may control access to the organization's resources (e.g., control what resources particular users are permitted to access, and what the users can do with the resources that they are permitted to access). For example, when a user of the organization (e.g., an employee of the organization) wishes to access the organization's resources, the user may be requested to log into an account associated with the organization. The user may provide user credentials, such as a combination of a username and a password or other information. The system may use the user credentials as authentication information to verify an identity of the user. Once authenticated, the system may determine whether the user has been granted permission or privileges to access the requested resources.

In some cases, the organization may subscribe to the services of a service provider, such as an identity management service provider, which may provide identity and access management services to the organization. In such cases, the identity management service provider may provide the identity and access management service to the organization as well as to other organizations. The multiple organizations may be customers, clients, or tenants of the identity management service provider, and the identity management service provider may maintain an identity management system (e.g., a multi-tenant identity management system) to manage the identities and access privileges of the users of the different organizations on behalf of those organizations. In some cases, the identity management system may provide multiple services to support the tenants' identity management needs. For instance, the identity management system may provide a cloud service, a single sign-on service, a multi-factor authentication service, a universal directory service, or the like, and such services may be referred to as products. As such, the tenants may subscribe to one or more services or products provided by the identity management system, and each tenant's individual usage of a product may be referred to as a product instance.

In some cases, each product instance may be maintained in a dedicated or isolated environment having computing resources configured and dedicated specifically for the particular tenant. In other cases, each product instance may be maintained in a multi-subscriber environment, wherein multiple distinct tenants are co-located in a manner that allows for the efficient sharing of computing resources amongst multiple tenants. Regardless of the type of environment in which each of the product instances resides, the identity management system may maintain data associated with each product instance within the corresponding environment. For example, for a given product instance, the identity management system may maintain (e.g., in the dedicated or shared environment) data such as users (e.g., the tenant's users), user groups, applications, permissions, authentication policies, tokens, etc. In some cases, such data may be maintained in multiple different databases within a given environment, such that a particular tenant's data may be distributed across the multiple databases. For instance, a tenant's user data may be in one database, while their permission data or token data is in a different database. In some cases, such databases may be associated with different database technologies.

In some cases, it may be beneficial to move a tenant's product instance from one environment to another, e.g., from a multi-subscriber environment to a dedicated environment or vice versa, from one dedicated environment to another, or from one multi-subscriber environment to another. For instance, the tenant may require additional or different computing resources, which may necessitate a move to a different environment. Migrating a product instance may require that the underlying data (e.g., users, user groups, applications, permissions, authentication policies, tokens, etc.) be replicated, exported from an original or source environment, and imported into the new or target environment.

However, because some replication technologies may operate at the database level (e.g., database object level), with each database operating with its own native database replication technology, the process of migrating data in distributed database environments may require a manual database-by-database approach, which may be time-consuming, inefficient, and, moreover, present challenges in preserving the integrity of data dependencies associated with the data, particularly when such migrations must occur in real time. By way of example, if a product instance to be migrated has user data and corresponding permission data, and if the user data is maintained in one database that is replicated from the source environment and migrated to the target environment prior to the replication and migration of the corresponding permission data maintained in a different database, a security issue may result, in which a user may be accessed before the user's access permissions have been fully migrated. This may be extended to other dependencies as well, such as deletion. For instance, when user data is deleted from one database, the users' corresponding session data maintained in a different database should also be deleted.

Conventional replication and migration techniques may not be aware of such dependencies and, thus, may not be able to preserve the integrity of the data during the replication and migration process. Further, because conventional replication and migration techniques operate at the database level, these conventional techniques may be tightly coupled to the underlying database technologies associated with the individual databases, which may differ in distributed database environments. This low level replication may present a challenge for using application level schema and API versioning at the database level. Furthermore, the lack of uniformity in native database replication and migration technologies may also create challenges with respect to standardizing a monitoring process.

In accordance with aspects described herein, an identity management system may replicate and migrate data at a product entity level, rather than at an individual database or database table level. For instance, the identity management system may replicate a complete product instead of the underlying database table. This may involve deploying agents that communicate with each individual database (e.g., in accordance with the corresponding native database technology associated with that database) where the underlying data is maintained, and performing ordering and dependency operations on top of each native replication protocol. The agents may implement a database-agnostic standardized interface to allow for a generic replication across different database technologies. For instance, in some implementations, in response to receiving a request to migrate data (e.g., data corresponding to a product) from a source environment to a target environment, the identity management system may identify, in the source environment, one or more source databases that include one or more product entities associated with the product. The identity management system may cause each of one or more source agents associated with the one or more source databases to export, into a payload-agnostic data structure, product entity source data associated with the one or more product entities, and may additionally cause one or more target agents associated with one or more target databases in the target environment to import, from the payload-agnostic data structure and into the one or more target databases, the product entity source data, and the product entity source data may be imported in accordance with one or more migration rules.

The described techniques may enable the identity management system to effectively and efficiently replicate and migrate data from databases implementing different database technologies in a uniform manner, while preserving the integrity of important data dependencies and allow for a standardized way to monitor multiple replication and migration processes across the identity management system.

Aspects of the disclosure are initially described in the context of a computing system. Aspects of the disclosure are further illustrated by and described with reference to apparatus diagrams, system diagrams, and flowcharts that relate to database-agnostic asynchronous product replication with atomic entities.

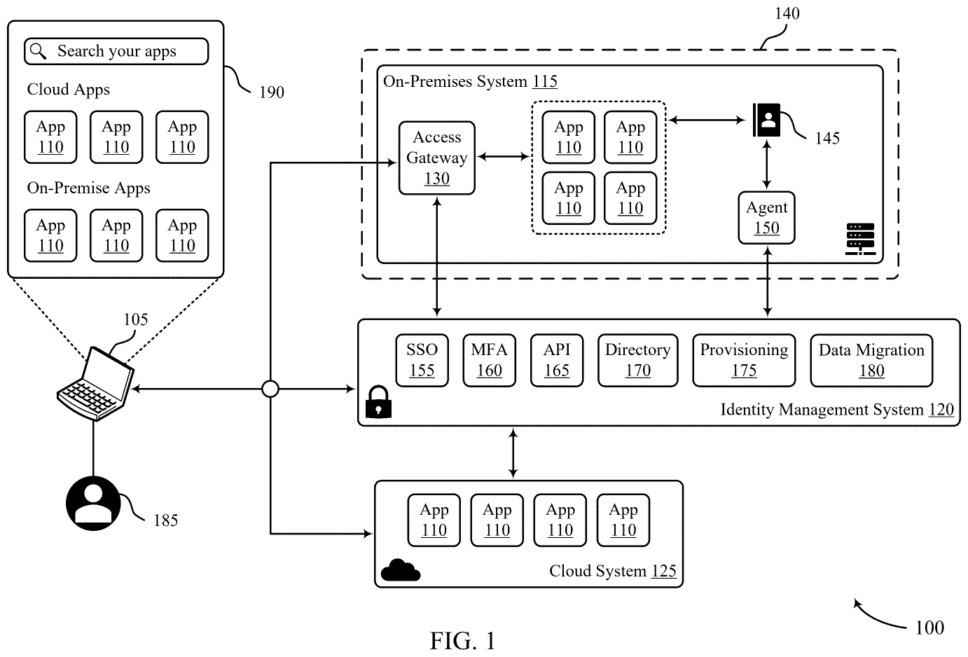

FIG. 1 illustrates an example of a computing system 100 that supports database-agnostic asynchronous product replication with atomic entities in accordance with various aspects of the present disclosure. The computing system 100 includes a computing device 105 (such as a desktop, laptop, smartphone, tablet, or the like), an on-premises system 115, an identity management system 120, and a cloud system 125, which may communicate with each other via a network, such as a wired network (e.g., the Internet), a wireless network (e.g., a cellular network, a wireless local area network (WLAN)), or both. In some cases, the network may be implemented as a public network, a private network, a secured network, an unsecured network, or any combination thereof. The network may include various communication links, hubs, bridges, routers, switches, ports, or other physical and/or logical network components, which may be distributed across the computing system 100.

The on-premises system 115 (also referred to as an on-premises infrastructure or environment) may be an example of a computing system in which a client organization owns, operates, and maintains its own physical hardware and/or software resources within its own data center(s) and facilities, instead of using cloud-based (e.g., off-site) resources. Thus, in the on-premises system 115, hardware, servers, networking equipment, and other infrastructure components may be physically located within the “premises” of the client organization, which may be protected by a firewall 140 (e.g., a network security device or software application that is configured to monitor, filter, and control incoming/outgoing network traffic). In some examples, users may remotely access or otherwise utilize compute resources of the on-premises system 115, for example, via a virtual private network (VPN).

In contrast, the cloud system 125 (also referred to as a cloud-based infrastructure or environment) may be an example of a system of compute resources (such as servers, databases, virtual machines, containers, and the like) that are hosted and managed by a third-party cloud service provider using third-party data center(s), which can be physically co-located or distributed across multiple geographic regions. The cloud system 125 may offer high scalability and a wide range of managed services, including (but not limited to) database management, analytics, machine learning (ML), artificial intelligence (AI), etc. Examples of cloud systems 125 include (Amazon Web Services) AWS®, Microsoft Azure®, Google Cloud Platform® Alibaba Cloud®, Oracle® Cloud Infrastructure (OCI), and the like.

The identity management system 120 may support one or more services, such as a single sign-on (SSO) service 155, a multi-factor authentication (MFA) service 160, an application programming interface (API) service 165, a directory management service 170, a provisioning service 175 or a data migration service 180 for various on-premises applications 110 (e.g., applications 110 running on compute resources of the on-premises system 115) and/or cloud applications 110 (e.g., applications 110 running on compute resources of the cloud system 125), among other examples of services. The SSO service 155, the MFA service 160, the API service 165, the directory management service 170, the provisioning service 175, and/or data migration service 180 may be individually or collectively provided (e.g., hosted) by one or more physical machines, virtual machines, physical servers, virtual (e.g., cloud) servers, data centers, or other compute resources managed by or otherwise accessible to the identity management system 120.

A user 185 may interact with the computing device 105 to communicate with one or more of the on-premises system 115, the identity management system 120, or the cloud system 125. For example, the user 185 may access one or more applications 110 by interacting with an interface 190 of the computing device 105. In some implementations, the user 185 may be prompted to provide some form of identification (such as a password, personal identification number (PIN), biometric information, or the like) before the interface 190 is presented to the user 185. In some implementations, the user 185 may be a developer, customer, employee, vendor, partner, or contractor of a client organization (such as a group, business, enterprise, non-profit, or startup that uses one or more services of the identity management system 120). The applications 110 may include one or more on-premises applications 110 (hosted by the on-premises system 115), mobile applications 110 (configured for mobile devices), and/or one or more cloud applications 110 (hosted by the cloud system 125).

The SSO service 155 of the identity management system 120 may allow the user 185 to access multiple applications 110 with one or more credentials. Once authenticated, the user 185 may access one or more of the applications 110 (for example, via the interface 190 of the computing device 105). That is, based on the identity management system 120 authenticating the identity of the user 185, the user 185 may obtain access to multiple applications 110, for example, without having to re-enter the credentials (or enter other credentials). The SSO service 155 may leverage one or more authentication protocols, such as Security Assertion Markup Language (SAML) or OpenID Connect (OIDC), among other examples of authentication protocols. In some examples, the user 185 may attempt to access an application 110 via a browser. In such examples, the browser may be redirected to the SSO service 155 of the identity management system 120, which may serve as the identity provider (IdP). For example, in some implementations, the browser (e.g., the user's request communicated via the browser) may be redirected by an access gateway 130 (e.g., a reverse proxy-based virtual application configured to secure web applications 110 that may not natively support SAML or OIDC).

In some examples, the access gateway 130 may support integrations with legacy applications 110 using hypertext transfer protocol (HTTP) headers and Kerberos tokens, which may offer universal resource locator (URL)-based authorization, among other functionalities. In some examples, such as in response to the user's request, the IdP may prompt the user 185 for one or more credentials (such as a password, PIN, biometric information, or the like) and the user 185 may provide the requested authentication credentials to the IdP. In some implementations, the IdP may leverage the MFA service 160 for added security. The IdP may verify the user's identity by comparing the credentials provided by the user 185 to credentials associated with the user's account. For example, one or more credentials associated with the user's account may be registered with the IdP (e.g., previously registered, or otherwise authorized for authentication of the user's identity via the IdP). The IdP may generate a security token (such as a SAML token or Oath 2.0 token) containing information associated with the identity and/or authentication status of the user 185 based on successful authentication of the user's identity.

The IdP may send the security token to the computing device 105 (e.g., the browser or application 110 running on the computing device 105). In some examples, the application 110 may be associated with a service provider (SP), which may host or manage the application 110. In such examples, the computing device 105 may forward the token to the SP. Accordingly, the SP may verify the authenticity of the token and determine whether the user 185 is authorized to access the requested applications 110. In some examples, such as examples in which the SP determines that the user 185 is authorized to access the requested application, the SP may grant the user 185 access to the requested applications 110, for example, without prompting the user 185 to enter credentials (e.g., without prompting the user to log-in). The SSO service 155 may promote improved user experience (e.g., by limiting the number of credentials the user 185 has to remember/enter), enhanced security (e.g., by leveraging secure authentication protocols and centralized security policies), and reduced credential fatigue, among other benefits.

The MFA service 160 of the identity management system 120 may enhance the security of the computing system 100 by prompting the user 185 to provide multiple authentication factors before granting the user 185 access to applications 110. These authentication factors may include one or more knowledge factors (e.g., something the user 185 knows, such as a password), one or more possession factors (e.g., something the user 185 is in possession of, such as a mobile app-generated code or a hardware token), or one or more inherence factors (e.g., something inherent to the user 185, such as a fingerprint or other biometric information). In some implementations, the MFA service 160 may be used in conjunction with the SSO service 155. For example, the user 185 may provide the requested login credentials to the identity management system 120 in accordance with an SSO flow and, in response, the identity management system 120 may prompt the user 185 to provide a second factor, such as a possession factor (e.g., a one-time passcode (OTP), a hardware token, a text message code, an email link/code). The user 185 may obtain access (e.g., be granted access by the identity management system 120) to the requested applications 110 based on successful verification of both the first authentication factor and the second authentication factor.

The API service 165 of the identity management system 120 can secure APIs by managing access tokens and API keys for various client organizations, which may enable (e.g., only enable) authorized applications (e.g., one or more of the applications 110) and authorized users (e.g., the user 185) to interact with a client organization's APIs. The API service 165 may enable client organizations to implement customizable login experiences that are consistent with their architecture, brand, and security configuration. The API service 165 may enable administrators to control user API access (e.g., whether the user 185 and/or one or more other users have access to one or more particular APIs). In some examples, the API service 165 may enable administrators to control API access for users via authorization policies, such as standards-based authorization policies that leverage OAuth 2.0. The API service 165 may additionally, or alternatively, implement role-based access control (RBAC) for applications 110. In some implementations, the API service 165 can be used to configure user lifecycle policies that automate API onboarding and off-boarding processes.

The directory management service 170 may enable the identity management system 120 to integrate with various identity sources of client organizations. In some implementations, the directory management service 170 may communicate with a directory service 145 of the on-premises system 115 via a software agent 150 installed on one or more computers, servers, and/or devices of the on-premises system 115. Additionally, or alternatively, the directory management service 170 may communicate with one or more other directory services, such as one or more cloud-based directory services. As described herein, a software agent 150 generally refers to a software program or component that operates on a system or device (such as a device of the on-premises system 115) to perform operations or collect data on behalf of another software application or system (such as the identity management system 120).

The provisioning service 175 of the identity management system 120 may support user provisioning and deprovisioning. For example, in response to an employee joining a client organization, the identity management system 120 may automatically create accounts for the employee and provide the employee with access to one or more resources via the accounts. Similarly, in response to the employee (or some other employee) leaving the client organization, the identity management system 120 may autonomously deprovision the employee's accounts and revoke the employee's access to the one or more resources (e.g., with little to no intervention from the client organization). The provisioning service 175 may maintain audit logs and records of user deprovisioning events, which may help the client organization demonstrate compliance and track user lifecycle changes. In some implementations, the provisioning service 175 may enable administrators to map user attributes and roles (e.g., permissions, privileges) between the identity management system 120 and connected applications 110, ensuring that user profiles are consistent across the identity management system 120, the on-premises system 115, and the cloud system 125.

The data migration service 180 of the identity management system 120 may support database agnostic replication and migration of data associated with a client organization. For instance, the data migration service 180 may be utilized to perform a replication and migration of a client organization's data, at the product level, from a source environment to a target environment. For instance, the identity management system 120 may utilize agents that communicate with individual databases that maintain product entity data associated with the product. The agents may communicate with the databases using a native database protocol associated with that database. The agents may further implement a database-agnostic standardized interface to allow for generic replication of data across different database technologies. As such, in some implementations, in response to receiving a request to migrate data (e.g., data corresponding to a product) from a source environment to a target environment, the identity management system 120 may identify, in the source environment, one or more source databases that include one or more product entities associated with the product requested for migration. The identity management system 120 may cause each of one or more source agents associated with the one or more source databases to export, into a payload-agnostic data structure, product entity source data associated with the one or more product entities, and may additionally cause one or more target agents associated with one or more target databases in the target environment to import, from the payload-agnostic data structure and into the one or more target databases, the product entity source data, and the product entity source data may be imported in accordance with one or more migration rules.

Although not depicted in the example of FIG. 1, a person skilled in the art would appreciate that the identity management system 120 may support or otherwise provide access to any number of additional or alternative services, applications 110, platforms, providers, or the like. In other words, the functionality of the identity management system 120 is not limited to the exemplary components and services mentioned in the preceding description of the computing system 100. The description herein is provided to enable a person skilled in the art to make or use the present disclosure. Various modifications to the present disclosure will be readily apparent to those skilled in the art, and the generic principles defined herein may be applied to other variations without departing from the scope of the present disclosure. Accordingly, the present disclosure is not limited to the examples and designs described herein, but is to be accorded the broadest scope consistent with the principles and novel features disclosed herein.

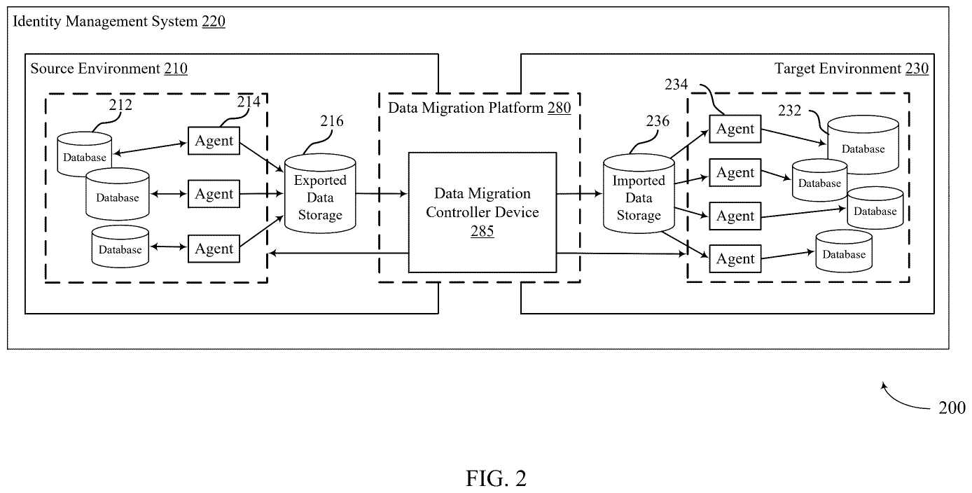

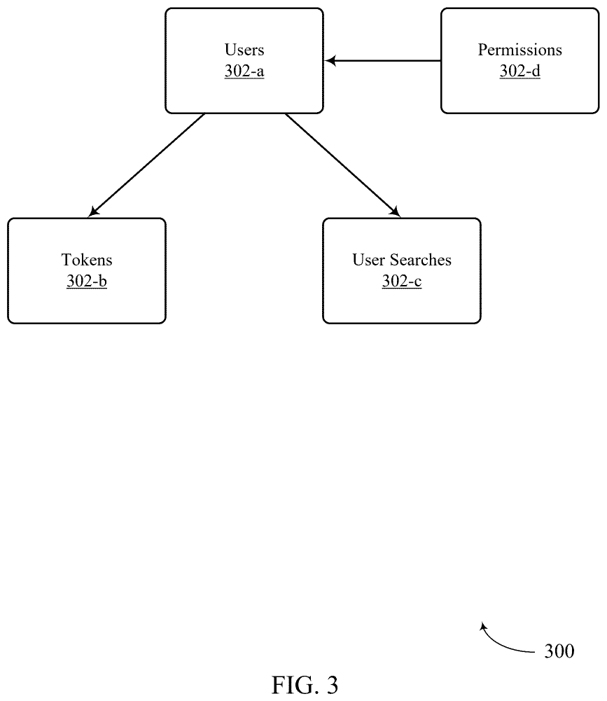

FIG. 2 shows an example of a system architecture 200 of an identity management system that supports database-agnostic asynchronous product replication with atomic entities in accordance with aspects of the present disclosure. FIG. 3 shows an example of a dependency graph 300 that supports database-agnostic asynchronous product replication with atomic entities in accordance with aspects of the present disclosure.

The system architecture 200 may be associated with an identity management system 220, which may be an example of the identity management system 120 described with reference to FIG. 1. The system architecture 200 may include a source environment 210, a target environment 230, and a data migration platform 280. The data migration platform 280 may be an example of a platform utilized by the identity management system 220 to provide the data migration service 180 described with reference to FIG. 1. The data migration platform 280 may include a data migration controller device 285 that may manage and control the migration of data between the source environment 210 and the target environment 230. The source environment 210 may be comprised of one or more source agents 214 that may be controlled by the data migration controller device 285 to communicate with one or more corresponding source databases 212 to export data from one or more of the source databases 212 into exported data storage 216. The target environment 230 may be comprised of one or more corresponding target agents 234 that may be controlled by the data migration controller device 285 to communicate with one or more corresponding target databases 232 to import data from imported data storage 236 into one or more of the target databases 232. In some implementations, the identity management system 220 may have more than one source environment 210 or more than one target environment 230.

In some implementations, the identity management system 220 may be a multi-tenant identity management system that provides multiple services or products to support the identity management needs of the tenants. As such, the tenants may subscribe to one or more services or products provided by the identity management system 220, and each tenant's individual usage of a product may be referred to as a product instance. The identity management system 220 may maintain data associated with each product instance within one or more environments of the identity management system 220, such as within the source environment 210 or the target environment 230. In some cases, the data (e.g., the tenants' data) associated with a given product instance may be maintained in the form of one or more product entities. For instance, the product entities may include organizations, users, groups, policies, permissions, tokens, user searches, rules, roles, logs, applications, configurations, etc. In some cases, different or additional product entities may be associated with a product instance. In some cases, different product instances may be associated with different product entities.

In some cases, the product entity data may be maintained in multiple databases within an environment. For instance, the product entity data may be maintained in multiple source databases 212 within the source environment 210, such that a particular tenant's product entity data may be distributed across the multiple source databases 212. For instance, a tenant's user data may be in one source database 212, while their permission data or token data may be in a different source database 212. As such, when there is a need to migrate data associated with a tenant's product instance, it may be important to preserve the integrity of any data (e.g., the product entity data) dependencies between data in one source database 212 and that in another source database 212.

As a result, in some implementations, at a time of onboarding a new product, an administrator (e.g., an administrator of a product group associated with the product) may register the new product with the data migration platform 280. Registering the product with the data migration platform 280 may enable the data associated with a tenant's instance of the product to be migrated using the data migration platform 280. During the registration process, the administrator may identify the product entities associated with the new product, define a mapping of the product entities to corresponding database objects in one or more databases, such as one or more source databases 212, and define a relationship between one or more of the product entities.

In some cases, the relationships may be maintained in a dependency graph, such as dependency graph 300 shown in FIG. 3. The dependency graph 300 may illustrate dependency relationships between one or more product entities 302, such as between a user's product entity 302-a, a tokens product entity 302-b, a user searches product entity 302-c, and a permissions product entity 302-d. It should be noted that the dependency graph 300 is a simplified version of a dependency graph, and in accordance with aspects described herein, the dependency graph 300 may, in some implementations, include any number of nodes and levels.

In some examples, the dependency graph 300 may be defined by an administrator using graph notation, such as:

Users (primary key:id)
Tokens −> Users (tokens.user_id, users.id)
User Searches −> Users (users_search.user_id, users.id)
Users −> Permissions (permissions.user_id, users.id)

The dependency graph 300 may show that both the tokens product entity 302-b and the user searches product entity 302-c are dependencies of the users product entity 302-a, while the users product entity 302-a is a dependency of the permissions product entity 302-d. The dependency graph 300 may be used to define migration rules that take into account such product entity dependencies when migrating the tenant's product entity 302 data. For instance, based on the dependency graph 300, one or more migration rules may be defined, such as a first rule that indicates that permissions data should be imported into (e.g., created in) the target databases 232 before users data is imported (e.g., created), a second rule that indicates that tokens data should be imported into the target databases 232 after users data is imported, a third rule that indicates that user searches data should be imported into the target databases 232 after users data is imported, and a fourth rule that indicates that if users data is deleted, permissions, tokens, and user searches data should also be deleted. In some cases, additional or different migration rules may be defined based on the dependency graph 300. The migration rules may, thereafter, be used when migrating a tenant's product data to ensure that the integrity of any data dependencies across the data is preserved.

Accordingly, there may be a need at some point to replicate and migrate data associated with a tenant's product instance from one environment (e.g., from the source environment 210) associated with the identity management system 220, to another environment (e.g., to the target environment 230) associated with the identity management system 220. Migrating a product instance may require that the underlying data (e.g., users, user groups, applications, permissions, policies, tokens, etc.) in the various source databases 212 be replicated and exported from the source environment 210 and, then subsequently, imported into one or more target databases 232 in the target environment 230.

In some cases, one or more of the source databases 212, one or more of the target databases 232, or a both may be associated with different database technologies (e.g., MONGODB, POSTGRESQL, DYNAMODB, REDIS, or other database technologies). For instance, a first source database 212 may be associated with a first database technology and a second source database 212 may be associated with a second database technology that is different from the first database technology. Additionally, or alternatively, a first target database 232 may be associated with a first database technology and a second target database 232 may be associated with a second database technology that is different from the first database technology.

In some cases, the data migration platform 280 (or the data migration controller device 285 operating at the data migration platform 280) may determine whether data associated with a product instance is to be migrated from the source environment 210 to the target environment 230. In some cases, the data migration controller device 285 may make the determination based on whether a tenant subscription ratio associated with the source environment 210 satisfies a subscription ratio threshold. The subscription ratio may represent a quantity of tenants that subscribe to the source environment 210 versus a total quantity of tenants that are capable of being supported by the source environment 210 (e.g., based on computing infrastructure and resources or other system constraints). For example, if 60 tenants subscribe to the source environment 210 where the source environment 210 is capable of supporting 100 tenants, the subscription ratio may be 60%. In some cases, the identity management system 220 may define, for one or more environments, a respective subscription ratio threshold (e.g., different environments may be associated with different subscription ratio threshold values). The subscription ratio threshold may represent a maximum subscription ratio at which the corresponding environment is able to maintain a quality of service (QoS) level associated with the environment. In some cases, when the subscription ratio threshold is satisfied (e.g., reached or exceeded), the identity management system 220 may determine that one or more tenants should be offloaded from the source environment 210 and moved to a different environment, e.g., the target environment 230. Accordingly, the identity management system 220 may monitor a subscription ratio associated with the source environment 210 and, based on detecting that the subscription ratio satisfies a corresponding subscription ratio threshold, may automatically trigger a request to the data migration platform 280 (to the data migration controller device 285 operating at the data migration platform 280) to perform data migration of one or more tenants (e.g., migration of data corresponding to one or more product instances associated with the one or more tenants) from the source environment 210 to the target environment 230. In some examples, the identity management system 220 may trigger a request to the data migration controller device 285 to perform data migration for other reasons. For instance, in some examples, the data migration request may be based on determining that an availability of multi-subscriber resources in the source environment 210 satisfies a resource threshold, based on a request from a tenant to transition to an environment with different or additional resources, or to transition from a multi-subscriber environment to a single subscriber environment or vice versa, or for any other reason.

Accordingly, the data migration platform 280 (or the data migration controller device 285) may receive a request to migrate, from the source environment 210 to the target environment 230, data associated with a product instance. The data migration controller device 285 may identify, in the source environment 210, one or more source databases 212 that include the data (e.g., the product entity 302 data) associated with the product instance. For instance, the data migration controller device 285 may identify the one or more source databases 212 that include the product entity 302 data associated with product based on the mapping of product entities 302 to database objects in the one or more source databases 212 that was defined during the onboarding process.

Based on identifying the particular source databases 212 that include the product entity 302 data associated with the product instance to be migrated, the data migration platform 280 (or the data migration controller device 285) may utilize (e.g., instruct) one or more source agents 214 to collect the product entity 302 data from the one or more source databases 212. For instance, each source agent 214 may be associated with one or more of the source databases 212. The source agents 214 may be configured to communicate with one or more of the source databases 212 using a native database language or protocol associated with that source database 212. For instance, a first source agent 214 configured to communicate according to a first database technology or protocol may communicate with one or more source databases 212 that implement the first database technology, while a second source agent 214 configured to communicate according to a second database technology or protocol may communicate with one or more source databases 212 that implement the second database technology.

The data migration controller device 285 may instruct one or more of the source agents 214 to retrieve data associated with particular product entities 302 from one or more of the source databases 212 that the source agent 214 is configured to communicate with. In some cases, the source agents 214 may be configured with the mapping of the various product entities 302 and the corresponding database objects that maintain the product entity 302 data. Accordingly, in some cases, the one or more source agents 214 may retrieve the requested product entity 302 data based on the mapping.

Upon retrieving the requested product entity 302 data, the one or more source agents 214 may replicate or export the retrieved product entity 302 data to a database-agnostic staging or data storage area, such as to an exported data storage 216. For instance, the source agents 214 may implement a database-agnostic interface that may allow for a generic replication or exportation of the product entity 302 data retrieved from across different databases and different database technologies. As such, each of the one or more source agents 214 may retrieve and then export (e.g., replicate) the product entity 302 data using a payload-agnostic data structure. In some cases, the payload-agnostic data structure may be referred to as a data atom. The data atom may include metadata, such as an identifier, timestamp, a collection (which may be an identification of a logical or related group of data, such as a type of the product entity 302, e.g., users, tokens, permissions, rules, etc.), a data atom type, a data atom status, etc., and payload data, such as information related to a particular product entity 302. In some implementations, the structure of the data atom may be implemented as follows (e.g., in a ‘struct’ type definition in a GO programming language, which may be serialized into JavaScript Object Notation (JSON)):

| type DataAtom struct { | | |
|---|---|---|
| ID | uuid.UUID | ‘json:“id”’ |
| Time | time.Time | ‘json:“timestamp”’ |
| Collection | string | ‘json:“collection”’ |
| Type | string | ‘json:“type”’ |
| Status | string | ‘json:“status”’ |
| Payload | any | ‘json:“payload”’ |

}

As an example, when the source agent 214 exports a user's product entity 302-a, the data atom may include information such as:

```
type DataAtom struct {
  “id”’: “7456938776-f89k-877h-iskjdmo678”,
  “timestamp”: “2024-01-01T15:20:00Z”,
  “collection”: “users”,
  “type”: “snapshot”,
  “status”: “active”,
  “payload”: “eyJJLKJHJGUYTGB93859JIsidf9098er99876ACRE01KhY”
}
```

Using the data atom, the payload of the data may be encapsulated in the data atom in both a database technology and product entity-agnostic manner. As a result, the source agent 214 may transmit the exported product entity 302 data (e.g., may transmit one or more data atoms including the product entity 302 data) to the exported data storage 216 in a generic and uniform manner and the data migration controller device 285 need not be aware of what the underlying data in the data atom is.

The data migration controller device 285 may, thereafter, retrieve the product entity 302 data from the exported data storage 216 and may transmit the data (e.g., using the data atom data structure) to the target environment 230, such as to a staging or data storage area at the target environment 230, such as an imported data storage 236 (e.g., the data may be stored in the data atom data structure). The data migration controller device 285 may utilize one or more target agents 234 to retrieve the data from the imported data storage 236 and import the data into one or more of the target databases 232. The target agents 234 may be configured to communicate with one or more of the target databases 232 using a native database language or protocol associated with that target database 232. For instance, a first target agent 234 configured to communicate according to a first database technology or protocol may communicate with one or more target databases 232 that implement the first database technology, while a second target agent 234 configured to communicate according to a second database technology or protocol may communicate with one or more target databases 232 that implement the second database technology.

The data migration controller device 285 may instruct one or more of the target agents 234 to retrieve the data from the imported data storage 236 and import the data into one or more of the target databases 232 that the target agent 234 is configured to communicate with. In some cases, one or more target agents 234 may read the metadata (e.g., in the data atom) of the imported product entity 302 data to determine a type of the data in the various data atoms that is to be imported and a corresponding target database 232. For instance, the target agents 234 may be configured (e.g., by an administrator during the product onboarding process) with a mapping of the various product entities 302 and the corresponding target databases 232 and database objects that maintain the data associated with those product entities 302. Accordingly, in some cases, the one or more of the target agents 234 may determine whether it is tasked with performing an import of the data to one of the target databases 232 that the target agent 234 communicates with, and if so, one or more database objects where the data should be imported into. In some cases, the data migration controller device 285 may instruct specific ones of the target agents 234 to perform the import, and the data migration controller device 285 may be aware of which target agents 234 to instruct, based on which of the source databases 212 the data was retrieved from. Accordingly, whether identified by the data migration controller device 285 or by the target agents 234 themselves, the appropriate target agents 234 may import the data from the imported data storage 236 (e.g., from the data atoms) into one or more of the target databases 232.

In some cases, the data migration may occur in real time while the source environment 210 operates as a live production environment. In such cases, there may be ongoing streams of data (e.g., production data) flowing into the source environment (e.g., into one or more of the source databases 212) while the data migration is occurring. As such, the data migration controller device 285 may buffer one or more of the data streams into buffer storage (e.g., exported data storage 216) during the data migration. The data migration controller device 285 may batch the streamed data in the buffer storage until the data migration is complete. Upon completion of the data migration, the data migration controller device 285 may retrieve the buffered streamed data from the exported data storage 216 and may transmit the data (e.g., using the data atom data structure) to the target environment 230, such as to the imported data storage 236 (e.g., where the data may be stored in the data atom data structure). The data migration controller device 285 may instruct one or more of the target agents 234 to retrieve the buffered streamed data from the imported data storage 236 and apply (e.g., import) the data to one or more of the target databases 232. In some cases, the data migration controller device 285 may control the target agents 234 to import (e.g., either during the data migration or when the buffered streamed data is applied) the data in accordance with one or more data migration rules defined using the dependency graph 300.

Accordingly, in some cases, while the data migration controller device 285 is buffering the one or more of the data streams into buffer storage, the one or more source agents 214 may listen for database events at the one or more data streams. For instance, each of the one or more source agents 214 may listen for database events at a data stream that corresponds to a source database 212 that the source agent 214 is associated with. As such, the one or more source agents 214 may listen for and detect database events, such as a create, update, or delete event that is associated with a product entity 302. As an example, a first source agent 214 associated with a first source database 212 that stores users product entity 302-a data may listen for and detect, on a data stream corresponding to the first source database 212, a create event for the creation of a new user.

Based on detecting a database event associated with a product entity 302, the source agent 214 or the data migration controller device 285 (e.g., based on receiving an indication of the detection from the source agent 214) may identify, using the dependency graph 300, one or more other product entities 302 that may be associated with the product entity 302 for which the database event was detected. For instance, if a create event associated with the users product entity 302-a is detected, the data migration controller device 285 may identify the tokens product entity 302-b, the user searches product entity 302-c, and the permissions product entity 302-d as the product entities 302 associated with the users product entity 302-a. In some cases, the data migration controller device 285 may cause (e.g., instruct) one or more of the source agents 214 to retrieve, from one or more of the source databases 212, data associated with the associated product entities 302, and to store the retrieved data in the buffer storage. In this way, an accurate snapshot of a state of the tenant's product data at that moment in time (e.g., such as when the create event associated with the users product entity 302-a is detected) may be captured.

Upon completion of the data migration, the data migration controller device 285 may retrieve the buffered streamed data (and the additional associated retrieved data) from the exported data storage 216 and may transmit the data to the imported data storage 236. The data migration controller device 285 may instruct one or more of the target agents 234 to retrieve the data from the imported data storage 236 and apply (e.g., import) the data to one or more of the target databases 232 in accordance with the one or more data migration rules defined based on the dependency graph 300. For instance, based on the first rule, the data associated with the permissions product entity 302-d may be imported prior to importing the data associated with the users product entity 302-a, and based on the second rule and the third rule, the data associated with the tokens product entity 302-b and the data associated with the user searches product entity 302-c may be imported after importing the data associated with the users product entity 302-a.

In some implementations, during the data migration, data migration controller device 285 may monitor one or more quality of service (QoS) metrics associated with the data migration. For instance, the data migration controller device 285 may monitor QoS metrics associated with the data being exported from the one or more source databases 212 in the source environment 210 and imported into the one or more target databases 232 in the target environment 230. The data migration controller device 285 may poll (e.g., periodically, aperiodically, randomly, etc.) one or more of the source agents 214 or the target agents 234 to receive statistics associated with the data migration in order to determine QoS metrics associated with completeness of the migration, data migration lag, data freshness, etc. For instance, completeness of the migration may be measured based on a percentage of the total quantity of records to be migrated from the one or more source databases 212 to the one or more target databases 232 that have been successfully migrated. The data migration lag may provide an indication of an amount of time it takes to process the data as it is being migrated. The data migration lag may be measured based on how far behind the data in the target databases 232 is from the data in the source databases 212. For instance, this may be determined based on a difference in time between a timestamp of the most recently-created record in the target databases 232 and a timestamp of the most recently-imported record in the source databases 212. For instance, if the timestamp of the most recently-created record in the target databases 232 is “2024 Jan. 1 00:00:00” and the timestamp of the most recently-imported record in the source databases 212 is “2024 Jan. 1 00:05:00” the data migration lag may be 5 minutes. The data freshness may be measured based on a difference between when a particular record (e.g., not necessarily a most recently-created record) is created in a source database 212 and when that same record is created in a corresponding target database 232. This metric may provide an indication of data freshness from the customer perspective. In some cases, different or additional metrics may be determined or measured.

As such, when polled, each of the different source agents 214 may provide, to the data migration controller device 285, statistics associated with the particular source databases 212 that the source agent 214 communicates with. The statistics may include a total quantity of records to be migrated from the source database 212, a quantity of records successfully migrated from the source database 212 to the one or more target databases thus far, a quantity of records remaining to be migrated from the one or more source databases 212, or the like. The data migration controller device 285 may compile the statistics received from the different source agents 214 to determine or calculate the QoS metrics. In some cases, the QoS metrics may be compared to one or more service level objectives defined for the data migration platform 280. For instance, the data migration controller device 285 may determine whether one or more of the QoS metrics satisfies (e.g., below) one or more corresponding service level thresholds. If one or more of the service level thresholds is satisfied, the data migration controller device 285 may send, to an operator (e.g., an administrator) a notification that the QoS metric satisfies the service level threshold or, in some cases, may restart or perform the data migration again for the product instance being migrated (e.g., requesting a new snapshot).

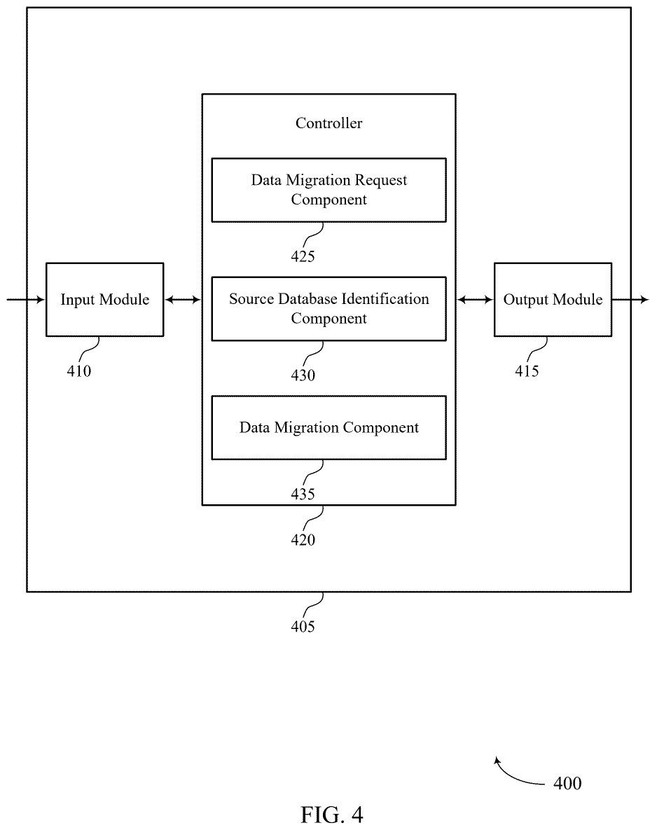

FIG. 4 shows a block diagram 400 of a device 405 that supports database-agnostic asynchronous product replication with atomic entities in accordance with aspects of the present disclosure. The device 405 may include an input module 410, an output module 415, and a controller 420. The device 405, or one or more components of the device 405 (e.g., the input module 410, the output module 415, the controller 420), may include at least one processor, which may be coupled with at least one memory, to support the described techniques. Each of these components may be in communication with one another (e.g., via one or more buses).

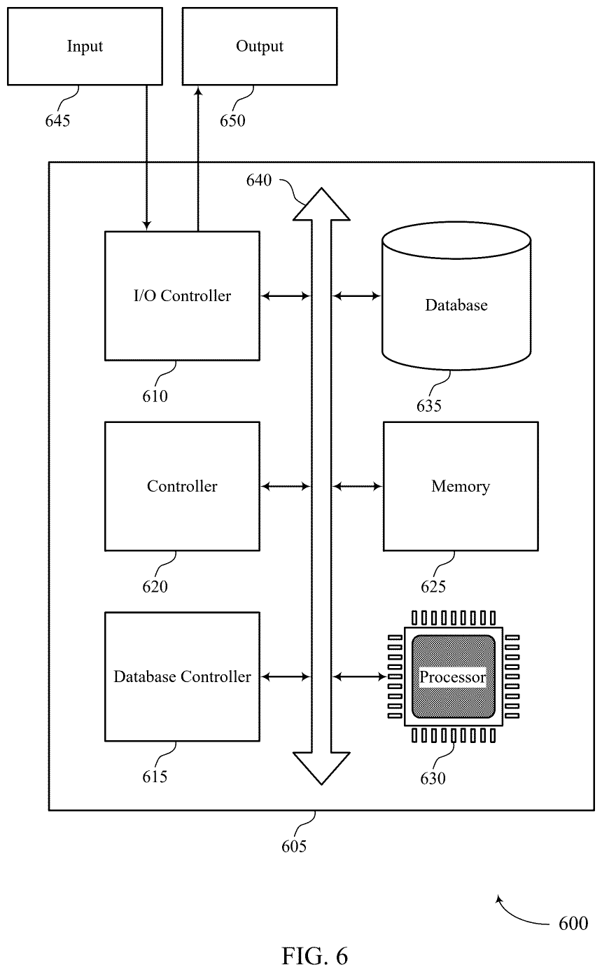

The input module 410 may manage input signals for the device 405. For example, the input module 410 may identify input signals based on an interaction with a modem, a keyboard, a mouse, a touchscreen, or a similar device. These input signals may be associated with user input or processing at other components or devices. In some cases, the input module 410 may utilize an operating system such as iOS®, ANDROID®, MS-DOS®, MS-WINDOWS®, OS/2®, UNIX®, LINUX®, or another known operating system to handle input signals. The input module 410 may send aspects of these input signals to other components of the device 405 for processing. For example, the input module 410 may transmit input signals to the controller 420 to support database-agnostic asynchronous product replication with atomic entities. In some cases, the input module 410 may be a component of an input/output (I/O) controller 610 as described with reference to FIG. 6.

The output module 415 may manage output signals for the device 405. For example, the output module 415 may receive signals from other components of the device 405, such as the controller 420, and may transmit these signals to other components or devices. In some examples, the output module 415 may transmit output signals for display in a user interface, for storage in a database or data store, for further processing at a server or server cluster, or for any other processes at any number of devices or systems. In some cases, the output module 415 may be a component of an I/O controller 610 as described with reference to FIG. 6.

For example, the controller 420 may include a data migration request component 425, a source database identification component 430, a data migration component 435, or any combination thereof. In some examples, the controller 420, or various components thereof, may be configured to perform various operations (e.g., receiving, monitoring, transmitting) using or otherwise in cooperation with the input module 410, the output module 415, or both. For example, the controller 420 may receive information from the input module 410, send information to the output module 415, or be integrated in combination with the input module 410, the output module 415, or both to receive information, transmit information, or perform various other operations as described herein.

The data migration request component 425 may be configured to support receiving a request to migrate, from a source environment to a target environment, data corresponding to a product associated with a customer. The source database identification component 430 may be configured to support identifying, in the source environment, one or more source databases that include one or more product entities associated with the product. The data migration component 435 may be configured to support migrating the data corresponding to the product, where migrating the data includes causing each of one or more source agents associated with the one or more source databases to export, into a payload-agnostic data structure, product entity source data associated with the one or more product entities, where the one or more source databases are associated with one or more different database technologies; and causing one or more target agents associated with one or more target databases in the target environment to import, from the payload-agnostic data structure and into the one or more target databases, the product entity source data, where the product entity source data is imported in accordance with one or more migration rules. The data migration component 435 may be configured to support causing each of one or more source agents associated with the one or more source databases to export, into a payload-agnostic data structure, product entity source data associated with the one or more product entities, where the one or more source databases are associated with one or more different database technologies. The data migration component 435 may be configured to support causing one or more target agents associated with one or more target databases in the target environment to import, from the payload-agnostic data structure and into the one or more target databases, the product entity source data, where the product entity source data is imported in accordance with one or more migration rules.

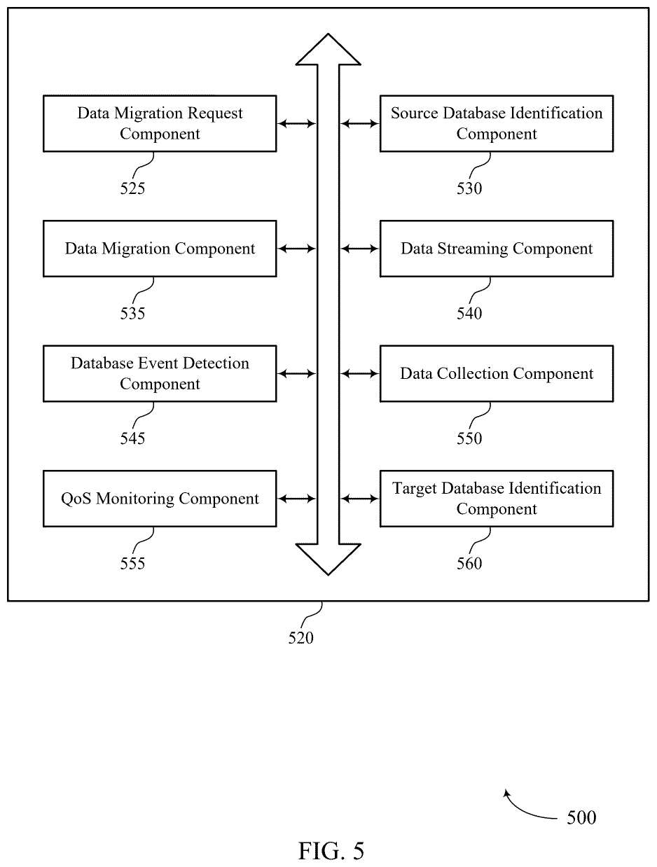

FIG. 5 shows a block diagram 500 of a controller 520 that supports database-agnostic asynchronous product replication with atomic entities in accordance with aspects of the present disclosure. The controller 520 may be an example of aspects of a controller or a controller 420, or both, as described herein. The controller 520, or various components thereof, may be an example of means for performing various aspects of database-agnostic asynchronous product replication with atomic entities as described herein. For example, the controller 520 may include a data migration request component 525, a source database identification component 530, a data migration component 535, a data streaming component 540, a database event detection component 545, a data collection component 550, a QoS monitoring component 555, a target database identification component 560, or any combination thereof. Each of these components, or components of subcomponents thereof (e.g., one or more processors, one or more memories), may communicate, directly or indirectly, with one another (e.g., via one or more buses).

The data migration request component 525 may be configured to support receiving a request to migrate, from a source environment to a target environment, data corresponding to a product associated with a customer. The source database identification component 530 may be configured to support identifying, in the source environment, one or more source databases that include one or more product entities associated with the product. The data migration component 535 may be configured to support migrating the data corresponding to the product, where migrating the data includes causing each of one or more source agents associated with the one or more source databases to export, into a payload-agnostic data structure, product entity source data associated with the one or more product entities, where the one or more source databases are associated with one or more different database technologies; and causing one or more target agents associated with one or more target databases in the target environment to import, from the payload-agnostic data structure and into the one or more target databases, the product entity source data, where the product entity source data is imported in accordance with one or more migration rules. In some examples, the data migration component 535 may be configured to support causing each of one or more source agents associated with the one or more source databases to export, into a payload-agnostic data structure, product entity source data associated with the one or more product entities, where the one or more source databases are associated with one or more different database technologies. In some examples, the data migration component 535 may be configured to support causing one or more target agents associated with one or more target databases in the target environment to import, from the payload-agnostic data structure and into the one or more target databases, the product entity source data, where the product entity source data is imported in accordance with one or more migration rules.

In some examples, the data streaming component 540 may be configured to support streaming one or more data streams from the one or more source databases into buffer storage. In some examples, the database event detection component 545 may be configured to support causing the one or more source agents to listen for database events at the one or more data streams. In some examples, the database event detection component 545 may be configured to support receiving, from a first source agent of the one or more source agents, an indication that a database event associated with a first entity is detected at a first data stream corresponding to a first source database of the one or more source databases. In some examples, the data collection component 550 may be configured to support causing, based on detecting the database event, the first source agent to collect, from one or more other source databases, data associated with one or more additional entities that are associated with the first entity. In some examples, the data collection component 550 may be configured to support causing the first source agent to store the collected data in the buffer storage. In some examples, the data migration component 535 may be configured to support causing, after completion of the migration, the one or more target agents to apply data from the buffer storage to the one or more target databases in accordance with the one or more migration rules.

In some examples, each source agent of the one or more source agents is configured to communicate with a corresponding source database of the one or more source databases.

In some examples, the one or more migration rules include one or more rules for determining, based on a dependency graph, an order for importing the product entity source data.

In some examples, the one or more product entities include a tenant, a user, a permission, an organization, a token, or a user search.

In some examples, the request to migrate data is received based on a subscription ratio associated with the source environment satisfying a threshold ratio.

In some examples, the request to migrate data is received based on an availability of multi-subscriber resources in the source environment satisfying a threshold.

In some examples, the QoS monitoring component 555 may be configured to support monitoring one or more quality of service (QoS) metrics associated with the one or more source databases and the one or more target databases, where the one or more QoS metrics include a quantity of records migrated to the one or more target databases, a quantity of records remaining in the one or more source databases, a percentage of the records from the one or more source databases that have been successfully migrated to the one or more target databases, a time lag associated with the migration, or a data freshness.

In some examples, the QoS monitoring component 555 may be configured to support sending, to an operator, a notification of the at least one QoS metric. In some examples, the QoS monitoring component 555 may be configured to support initiating a second request to migrate data corresponding to the product.

In some examples, the target database identification component 560 may be configured to support identifying, based on the one or source databases, the one or more target databases into which to import the product entity source data.

FIG. 6 shows a diagram of a system 600 including a device 605 that supports database-agnostic asynchronous product replication with atomic entities in accordance with aspects of the present disclosure. The device 605 may be an example of or include components of a device 405 as described herein. The device 605 may include components for bi-directional voice and data communications including components for transmitting and receiving communications, such as a controller 620, an I/O controller, such as an I/O controller 610, a database controller 615, at least one memory 625, at least one processor 630, and a database 635. These components may be in electronic communication or otherwise coupled (e.g., operatively, communicatively, functionally, electronically, electrically) via one or more buses (e.g., a bus 640).

The I/O controller 610 may manage input signals 645 and output signals 650 for the device 605. The I/O controller 610 may also manage peripherals not integrated into the device 605. In some cases, the I/O controller 610 may represent a physical connection or port to an external peripheral. In some cases, the I/O controller 610 may utilize an operating system such as iOS®, ANDROID®, MS-DOS®, MS-WINDOWS®, OS/2®, UNIX®, LINUX®, or another known operating system. In other cases, the I/O controller 610 may represent or interact with a modem, a keyboard, a mouse, a touchscreen, or a similar device. In some cases, the I/O controller 610 may be implemented as part of a processor 630. In some examples, a user may interact with the device 605 via the I/O controller 610 or via hardware components controlled by the I/O controller 610.

The database controller 615 may manage data storage and processing in a database 635. In some cases, a user may interact with the database controller 615. In other cases, the database controller 615 may operate automatically without user interaction. The database 635 may be an example of a single database, a distributed database, multiple distributed databases, a data store, a data lake, or an emergency backup database.

Memory 625 may include random-access memory (RAM) and read-only memory (ROM). The memory 625 may store computer-readable, computer-executable software including instructions that, when executed, cause at least one processor 630 to perform various functions described herein. In some cases, the memory 625 may contain, among other things, a basic I/O system (BIOS) which may control basic hardware or software operation such as the interaction with peripheral components or devices. The memory 625 may be an example of a single memory or multiple memories. For example, the device 605 may include one or more memories 625.

The processor 630 may include an intelligent hardware device (e.g., a general-purpose processor, a digital signal processor (DSP), a central processing unit (CPU), a microcontroller, an application-specific integrated circuit (ASIC), a field-programmable gate array (FPGA), a programmable logic device, a discrete gate or transistor logic component, a discrete hardware component, or any combination thereof). In some cases, the processor 630 may be configured to operate a memory array using a memory controller. In other cases, a memory controller may be integrated into the processor 630. The processor 630 may be configured to execute computer-readable instructions stored in at least one memory 625 to perform various functions (e.g., functions or tasks supporting database-agnostic asynchronous product replication with atomic entities). The processor 630 may be an example of a single processor or multiple processors. For example, the device 605 may include one or more processors 630.

For example, the controller 620 may be configured to support receiving a request to migrate, from a source environment to a target environment, data corresponding to a product associated with a customer. The controller 620 may be configured to support identifying, in the source environment, one or more source databases that include one or more product entities associated with the product. The controller 620 may be configured to support migrating the data corresponding to the product, where migrating the data includes causing each of one or more source agents associated with the one or more source databases to export, into a payload-agnostic data structure, product entity source data associated with the one or more product entities, where the one or more source databases are associated with one or more different database technologies; and causing one or more target agents associated with one or more target databases in the target environment to import, from the payload-agnostic data structure and into the one or more target databases, the product entity source data, where the product entity source data is imported in accordance with one or more migration rules. The controller 620 may be configured to support causing each of one or more source agents associated with the one or more source databases to export, into a payload-agnostic data structure, product entity source data associated with the one or more product entities, where the one or more source databases are associated with one or more different database technologies. The controller 620 may be configured to support causing one or more target agents associated with one or more target databases in the target environment to import, from the payload-agnostic data structure and into the one or more target databases, the product entity source data, where the product entity source data is imported in accordance with one or more migration rules.

By including or configuring the controller 620 in accordance with examples as described herein, the device 605 may support techniques for improved data security, improved user experience related to reduced processing, reduced power consumption, more efficient utilization of computing resources, and improved coordination between systems.

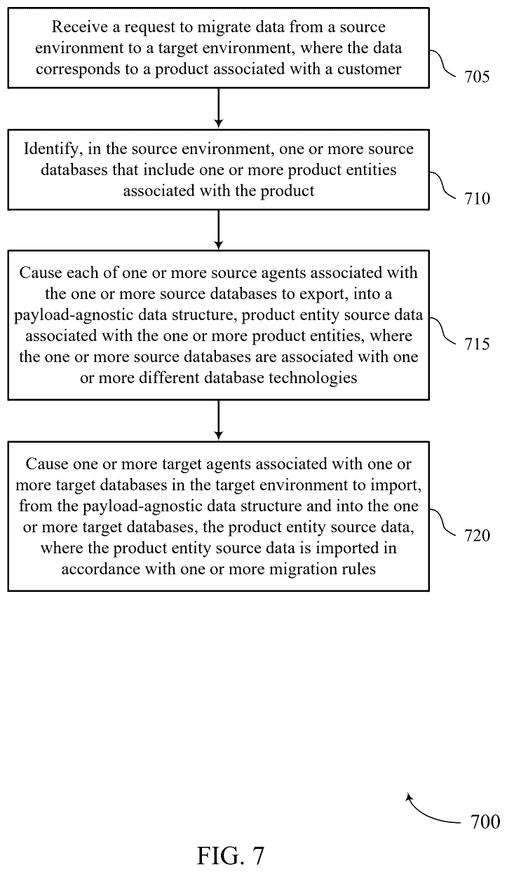

FIG. 7 shows a flowchart illustrating a method 700 that supports database-agnostic asynchronous product replication with atomic entities in accordance with aspects of the present disclosure. The operations of the method 700 may be implemented by an identity management system device or its components as described herein. For example, the operations of the method 700 may be performed by an identity management system device as described with reference to FIGS. 1 through 6. In some examples, an identity management system device may execute a set of instructions to control the functional elements of the identity management system device to perform the described functions. Additionally, or alternatively, the identity management system device may perform aspects of the described functions using special-purpose hardware.

At 705, the method may include receiving a request to migrate, from a source environment to a target environment, data corresponding to a product associated with a customer. The operations of 705 may be performed in accordance with examples as disclosed herein. In some examples, aspects of the operations of 705 may be performed by a data migration request component 525 as described with reference to FIG. 5.

At 710, the method may include identifying, in the source environment, one or more source databases that include one or more product entities associated with the product. The operations of 710 may be performed in accordance with examples as disclosed herein. In some examples, aspects of the operations of 710 may be performed by a source database identification component 530 as described with reference to FIG. 5.

The method may include migrating the data corresponding to the product.

At 715, migrating the data may include causing each of one or more source agents associated with the one or more source databases to export, into a payload-agnostic data structure, product entity source data associated with the one or more product entities, where the one or more source databases are associated with one or more different database technologies. The operations of 715 may be performed in accordance with examples as disclosed herein. In some examples, aspects of the operations of 715 may be performed by a data migration component 535 as described with reference to FIG. 5.

At 720, migrating the data may further include causing one or more target agents associated with one or more target databases in the target environment to import, from the payload-agnostic data structure and into the one or more target databases, the product entity source data, where the product entity source data is imported in accordance with one or more migration rules. The operations of 720 may be performed in accordance with examples as disclosed herein. In some examples, aspects of the operations of 720 may be performed by a data migration component 535 as described with reference to FIG. 5.

The following provides an overview of aspects of the present disclosure:
Aspect 1: A method by a migration controller device associated with a migration platform, comprising: receiving a request to migrate, from a source environment to a target environment, data corresponding to a product associated with a customer; identifying, in the source environment, one or more source databases that comprise one or more product entities associated with the product; and migrating the data corresponding to the product, wherein migrating the data comprises: causing each of one or more source agents associated with the one or more source databases to export, into a payload-agnostic data structure, product entity source data associated with the one or more product entities, wherein the one or more source databases are associated with one or more different database technologies; and causing one or more target agents associated with one or more target databases in the target environment to import, from the payload-agnostic data structure and into the one or more target databases, the product entity source data, wherein the product entity source data is imported in accordance with one or more migration rules.
Aspect 2: The method of aspect 1, further comprising; while performing the migration of the data corresponding to the product: streaming one or more data streams from the one or more source databases into buffer storage; causing the one or more source agents to listen for database events at the one or more data streams; receiving, from a first source agent of the one or more source agents, an indication that a database event associated with a first entity is detected at first data stream corresponding to a first source database of the one or more source databases; causing, based at least in part on detecting the database event, the first source agent to collect, from one or more other source databases, data associated with one or more additional entities that are associated with the first entity; and causing the first source agent to store the collected data in the buffer storage; and causing, after completion of the migration, the one or more target agents to apply data from the buffer storage to the one or more target databases in accordance with the one or more migration rules.
Aspect 3: The method of any of aspects 1 through 2, wherein each source agent of the one or more source agents is configured to communicate with a corresponding source database of the one or more source databases.
Aspect 4: The method of any of aspects 1 through 3, wherein the one or more migration rules comprise one or more rules for determining, based on a dependency graph, an order for importing the product entity source data.
Aspect 5: The method of any of aspects 1 through 4, wherein the one or more product entities comprise a tenant, a user, a permission, an organization, a token, or a user search.
Aspect 6: The method of any of aspects 1 through 5, wherein the request to migrate data is received based at least in part on a subscription ratio associated with the source environment satisfying a threshold ratio.
Aspect 7: The method of any of aspects 1 through 6, wherein the request to migrate data is received based at least in part on an availability of multi-subscriber resources in the source environment satisfying a threshold.
Aspect 8: The method of any of aspects 1 through 7, further comprising: monitoring one or more quality of service (QoS) metrics associated with the one or more source databases and the one or more target databases, wherein the one or more QoS metrics comprise a quantity of records migrated to the one or more target databases, a quantity of records remaining in the one or more source databases, a percentage of the records from the one or more source databases that have been successfully migrated to the one or more target databases, a time lag associated with the migration, or a data freshness.
Aspect 9: The method of aspect 8, further comprising, based at least in part on at least one QoS metric of the one or more QoS metrics satisfying a service level threshold: sending, to an operator, a notification of the at least one QoS metric, or initiating a second request to migrate data corresponding to the product.
Aspect 10: The method of any of aspects 1 through 9, further comprising: identifying, based at least in part on the one or source databases, the one or more target databases into which to import the product entity source data.
Aspect 11: A migration controller device associated with a migration platform comprising one or more memories storing processor-executable code, and one or more processors coupled with the one or more memories and individually or collectively operable to execute the code to cause the migration controller device associated with a migration platform to perform a method of any of aspects 1 through 10.
Aspect 12: A migration controller device associated with a migration platform comprising at least one means for performing a method of any of aspects 1 through 10.
Aspect 13: A non-transitory computer-readable medium storing code the code comprising instructions executable by one or more processors to perform a method of any of aspects 1 through 10.

It should be noted that the methods described herein describe possible implementations, and that the operations and the steps may be rearranged or otherwise modified and that other implementations are possible. Furthermore, aspects from two or more of the methods may be combined.

The description set forth herein, in connection with the appended drawings, describes example configurations, and does not represent all the examples that may be implemented, or that are within the scope of the claims. The term “exemplary” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and devices are shown in block diagram form in order to avoid obscuring the concepts of the described examples.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

Information and signals described herein may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a DSP, an ASIC, an FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by one or more processors, firmware, or any combination thereof. If implemented in software executed by one or more processors, the functions may be stored on or transmitted over as one or more instructions or code on a computer-readable medium. Other examples and implementations are within the scope of the disclosure and appended claims. For example, due to the nature of software, functions described herein can be implemented using software executed by a processor, hardware, firmware, hardwiring, or combinations of any of these. Features implementing functions may also be physically located at various positions, including being distributed such that portions of functions are implemented at different physical locations.

Also, as used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media can comprise RAM, ROM, electrically erasable programmable ROM (EEPROM), compact disk (CD) ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor.

Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, the article “a” before a noun is open-ended and understood to refer to “at least one” of those nouns or “one or more” of those nouns. Thus, the terms “a,” “at least one,” “one or more,” “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The description herein is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not limited to the examples and designs described herein, but is to be accorded the broadest scope consistent with the principles and novel features disclosed herein.

1. A method by a migration controller device associated with a migration platform, comprising:
receiving a request to migrate, from a source environment to a target environment, data corresponding to a product associated with a customer;
identifying, in the source environment, one or more source databases that comprise one or more product entities associated with the product; and
migrating the data corresponding to the product, wherein migrating the data comprises:
causing each of one or more source agents associated with the one or more source databases to export, into a payload-agnostic data structure, product entity source data associated with the one or more product entities, wherein the one or more source databases are associated with one or more different database technologies; and
causing one or more target agents associated with one or more target databases in the target environment to import, from the payload-agnostic data structure and into the one or more target databases, the product entity source data, wherein the product entity source data is imported in accordance with one or more migration rules.

2. The method of claim 1, further comprising:
while performing the migration of the data corresponding to the product:
streaming one or more data streams from the one or more source databases into buffer storage;
causing the one or more source agents to listen for database events at the one or more data streams;
receiving, from a first source agent of the one or more source agents, an indication that a database event associated with a first entity is detected at first data stream corresponding to a first source database of the one or more source databases;
causing, based at least in part on detecting the database event, the first source agent to collect, from one or more other source databases, data associated with one or more additional entities that are associated with the first entity;
causing the first source agent to store the collected data in the buffer storage; and
causing, after completion of the migration, the one or more target agents to apply data from the buffer storage to the one or more target databases in accordance with the one or more migration rules.

3. The method of claim 1, wherein each source agent of the one or more source agents is configured to communicate with a corresponding source database of the one or more source databases.

4. The method of claim 1, wherein the one or more migration rules comprise one or more rules for determining, based on a dependency graph, an order for importing the product entity source data.

5. The method of claim 1, wherein the one or more product entities comprise a tenant, a user, a permission, an organization, a token, or a user search.

6. The method of claim 1, wherein the request to migrate data is received based at least in part on a subscription ratio associated with the source environment satisfying a threshold ratio.

7. The method of claim 1, wherein the request to migrate data is received based at least in part on an availability of multi-subscriber resources in the source environment satisfying a threshold.

8. The method of claim 1, further comprising:
monitoring one or more quality of service (QoS) metrics associated with the one or more source databases and the one or more target databases, wherein the one or more QoS metrics comprise a quantity of records migrated to the one or more target databases, a quantity of records remaining in the one or more source databases, a percentage of the records from the one or more source databases that have been successfully migrated to the one or more target databases, a time lag associated with the migration, or a data freshness.

9. The method of claim 8, further comprising, based at least in part on at least one QoS metric of the one or more QoS metrics satisfying a service level threshold:
sending, to an operator, a notification of the at least one QoS metric, or
initiating a second request to migrate data corresponding to the product.

10. The method of claim 1, further comprising:
identifying, based at least in part on the one or more source databases, the one or more target databases into which to import the product entity source data.

11. A migration controller device associated with a migration platform, comprising:
one or more memories storing processor-executable code; and
one or more processors coupled with the one or more memories and individually or collectively operable to execute the code to cause the migration controller device associated with a migration platform to:
receive a request to migrate, from a source environment to a target environment, data corresponding to a product associated with a customer;
identify, in the source environment, one or more source databases that comprise one or more product entities associated with the product; and
migrate the data corresponding to the product, wherein migration of the data comprises:
cause each of one or more source agents associated with the one or more source databases to export, into a payload-agnostic data structure, product entity source data associated with the one or more product entities, wherein the one or more source databases are associated with one or more different database technologies; and
cause one or more target agents associated with one or more target databases in the target environment to import, from the payload-agnostic data structure and into the one or more target databases, the product entity source data, wherein the product entity source data is imported in accordance with one or more migration rules.

12. The migration controller device of claim 11, wherein the one or more processors are individually or collectively further operable to execute the code to cause the migration controller device associated with a migration platform to:
while the migration of the data corresponding to the product is being performed:
stream one or more data streams from the one or more source databases into buffer storage;
cause the one or more source agents to listen for database events at the one or more data streams;
receive, from a first source agent of the one or more source agents, an indication that a database event associated with a first entity is detected at first data stream corresponding to a first source database of the one or more source databases;
cause, based at least in part on detecting the database event, the first source agent to collect, from one or more other source databases, data associated with one or more additional entities that are associated with the first entity;
cause the first source agent to store the collected data in the buffer storage; and
cause, after completion of the migration, the one or more target agents to apply data from the buffer storage to the one or more target databases in accordance with the one or more migration rules.

13. The migration controller device of claim 11, wherein each source agent of the one or more source agents is configured to communicate with a corresponding source database of the one or more source databases.

14. The migration controller device of claim 11, wherein the one or more migration rules comprise one or more rules for determining, based on a dependency graph, an order for importing the product entity source data.

15. The migration controller device of claim 11, wherein the one or more product entities comprise a tenant, a user, a permission, an organization, a token, or a user search.

16. The migration controller device of claim 11, wherein the request to migrate data is received based at least in part on a subscription ratio associated with the source environment satisfying a threshold ratio.

17. The migration controller device of claim 11, wherein the request to migrate data is received based at least in part on an availability of multi-subscriber resources in the source environment satisfying a threshold.

18. The migration controller device of claim 11, wherein the one or more processors are individually or collectively further operable to execute the code to cause the migration controller device associated with a migration platform to:
monitor one or more quality of service (QoS) metrics associated with the one or more source databases and the one or more target databases, wherein the one or more QoS metrics comprise a quantity of records migrated to the one or more target databases, a quantity of records remaining in the one or more source databases, a percentage of the records from the one or more source databases that have been successfully migrated to the one or more target databases, a time lag associated with the migration, or a data freshness; and
based at least in part on at least one QoS metric of the one or more QoS metrics satisfying a service level threshold:
send, to an operator, a notification of the at least one QoS metric, or
initiate a second request to migrate data corresponding to the product.

19. The migration controller device of claim 11, wherein the one or more processors are individually or collectively further operable to execute the code to cause the migration controller device associated with a migration platform to:
identify, based at least in part on the one or more source databases, the one or more target databases into which to import the product entity source data.

20. A non-transitory computer-readable medium storing code, the code comprising instructions executable by one or more processors to:
receive a request to migrate, from a source environment to a target environment, data corresponding to a product associated with a customer;
identify, in the source environment, one or more source databases that comprise one or more product entities associated with the product; and
migrate the data corresponding to the product, wherein migrating the data comprises:
cause each of one or more source agents associated with the one or more source databases to export, into a payload-agnostic data structure, product entity source data associated with the one or more product entities, wherein the one or more source databases are associated with one or more different database technologies; and
cause one or more target agents associated with one or more target databases in the target environment to import, from the payload-agnostic data structure and into the one or more target databases, the product entity source data, wherein the product entity source data is imported in accordance with one or more migration rules.
